(19) United States
(12) Patent Application Publication
(10) Pub. No.: US 2014/0347797 A1
(43) Pub. Date: Nov. 27, 2014

(54) ALL-IN-ONE COMPUTER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: XIAO-YONG MA, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/138,440

(22) Filed: Dec. 23, 2013

(30) Foreign Application Priority Data
May 23, 2013 (CN) 2013101930094

(51) Int. Cl. G06F 1/16

(52) U.S. Cl. CPC G06F 1/16
USPC 361/679.2

(57) ABSTRACT

An all-in-one computer includes a computer main body, a keyboard, and two connecting structures. The computer main body includes a front surface and a back surface opposite to the front surface. Each of the two connecting structures is pivotably connected to the computer main body and the keyboard. Each of the two connecting structures is rotatable relative to the computer main body along a first direction to rotate the keyboard to be an idle position, where the keyboard is located on the back of the back surface and abuts the back surface, along a second direction opposite to the first direction to rotate the keyboard to be a used position, wherein the keyboard is located on the front of the front surface.

### BACKGROUND

1. Technical Field

The present disclosure relates to an all-in-one computer.

2. Description of Related Art

A typical all-in-one computer includes a computer main body and a keyboard separated with the computer main body. The separately placed keyboard and the computer main body may occupy a mount of space when the all-in-one computer is not used. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an all-in-one computer according to an embodiment.

FIG. 2 is an enlarged view of a circled portion II of the all-in-one computer of FIG. 1.

FIG. 3 is an enlarged view of a circled portion III of the all-in-one computer of FIG. 1.

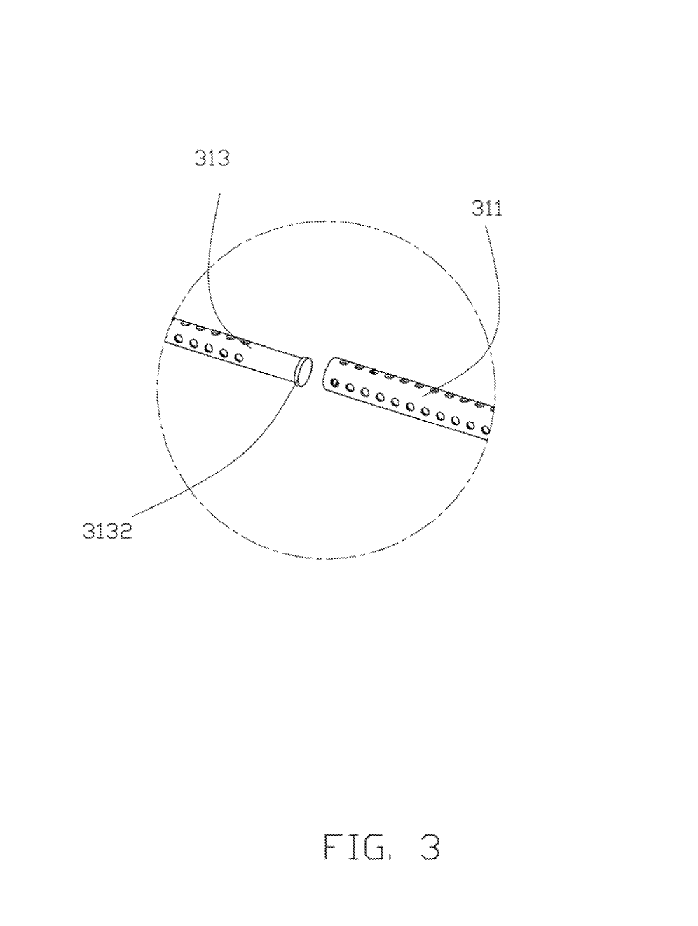

FIG. 4 is an assembled view of the all-in-one computer of FIG. 1, showing the second pole at a retracted position and the keyboard at a first position.

FIG. 5 is an assembled view of the all-in-one computer of FIG. 1, showing the second pole at a stretched position and the keyboard at the first position.

FIG. 6 is an assembled view of the all-in-one computer of FIG. 1, showing the keyboard at a second position.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

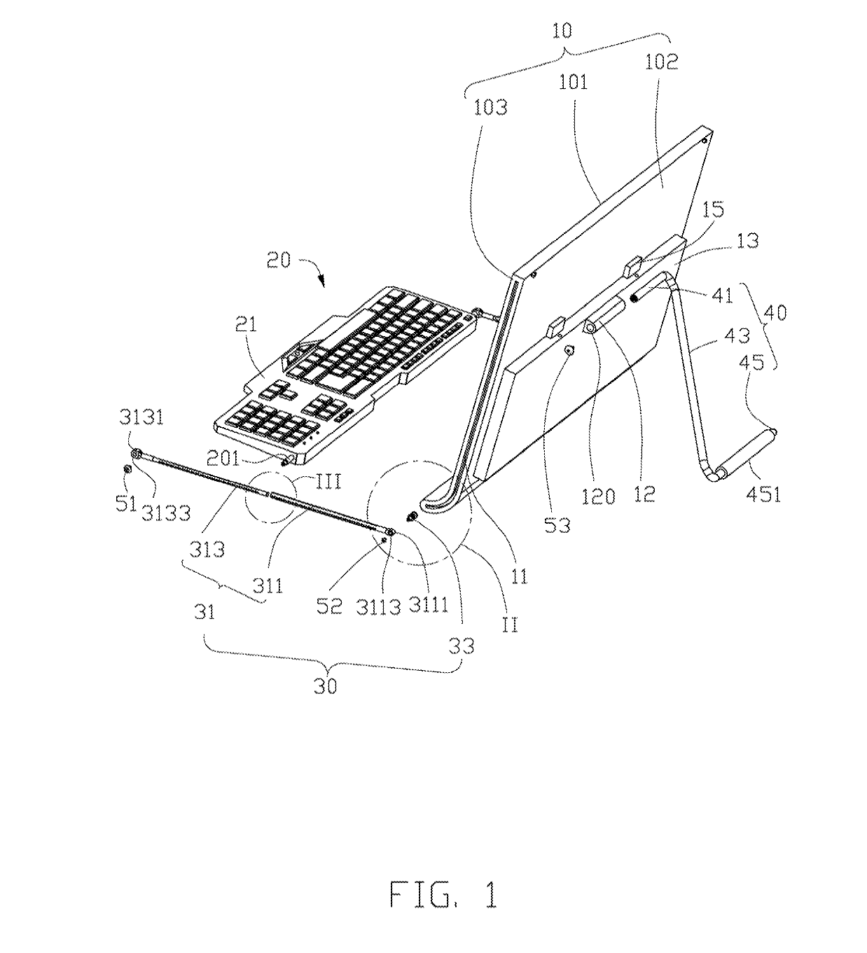

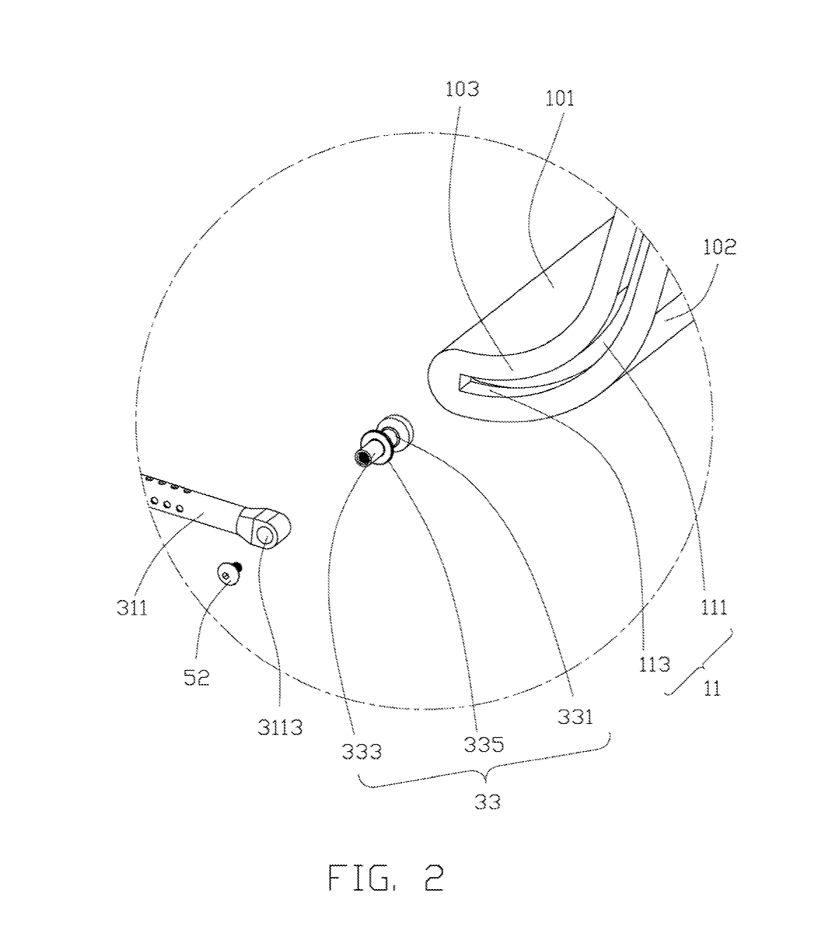

FIGS. 1 and 2 show an embodiment of an all-in-one computer. The all-in-one computer includes a computer main body 10, a keyboard 20, two connecting structures 30, and a supporting member 40. The keyboard 20 includes a keyboard main body 21 and two pivot posts 201. The two pivot posts 201 are located on opposite sides of the keyboard main body 21, for connecting the two connecting structures 30.

The computer main body 10 includes a front surface 101, a back surface 102 opposite to the front surface 101, and two sidewalls 103. The two side walls 103 are connected to the front surface 101 and the back surface 102, respectively. A monitor 14 is embedded in the front surface 101. A protrusion block 13 is located on the back surface 102 and comprises a top edge 131. A fixing portion 12 is located on the protrusion block 13 and adjacent to a top edge 131. A fixing hole 120 is defined in the fixing portion 12, for corresponding to the supporting member 40. The fixing hole 120 extends through the fixing portion 12 and has an extension direction that is substantially parallel to the top edge 131. Two wedge-shaped resisting blocks 15 are located on the back surface 102 and connected to the protrusion block 13, for supporting the keyboard 20. In one embodiment, each of the two resisting blocks 15 has a maximum thickness along a direction that is perpendicular to the back surface 102, and the maximum thickness is less than a thickness of the protrusion block 13.

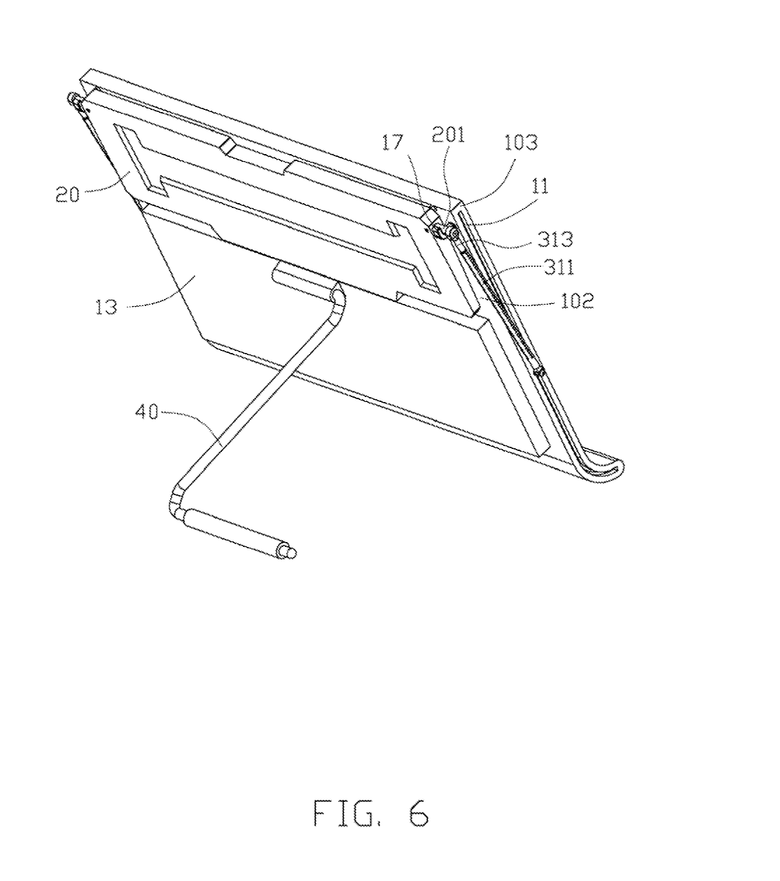

Two hooks 17 (only shown in FIG. 6) are located on the back surface 102 and arranged on a same line which is substantially parallel to the top edge 131. Each of the two side walls 103 defines an elongated slot 11. In one embodiment, the elongated slot 11 is substantially J-shaped. The elongated slot 11 includes a wide portion 111 and a narrow portion 113 in communication with the wide portion 111.

Each of the connecting structures 30 includes a connecting member 31 and a sliding member 33. The connecting member 31 includes a first pole 311 and a second pole 313 partially slidably received in the first pole 311. In one embodiment, the first pole 311 and the second pole 313 are both substantially columnar, and an inner diameter of the first pole 311 is slightly greater than an outer diameter of the second pole 313. The first pole 311 defines an accommodation hole (not shown) for receiving the second pole 313. A first installation portion 3111 is located on a first end of the first pole 311, and a blocking flange (not shown) extends from an inner sidewall of the first pole and is adjacent to a second end opposite to the first end of the first pole 311. The first installation portion 3111 defines a first installation hole 3113 corresponding to the sliding member 33. A second installation portion 3131 is located on a first end of the second pole 313 away from the first pole 311, and a stopping tab 3132 is located in a second end opposite to the first end of the second pole 313. The second installation portion 3131 defines a second installation portion 3133 corresponding to each pivot post 201.

The sliding member 33 includes a sliding portion 331, a rotating shaft 333, and a limiting spacer 335 located on the rotating shaft 333. The sliding portion 331 has substantially columnar and can be resiliently deformed to be extended through the narrow portion 113 and engaged into the wide portion 111. The rotating shaft 333 is integrated with the sliding portion 331 and has an outer diameter. The outer diameter of the rotating shaft 333 is slightly smaller than a width of the narrow portion 113. The limiting spacer 335 surrounds the rotating shaft 333 and has an outer diameter and arranged at a middle portion of the limiting spacer 335. The outer diameter of the limiting spacer 335 is slightly greater than the width of the narrow portion 113.

The supporting member 40 includes an installation pole 41, a supporting pole 43, and a resisting pole 45. The installation pole 41 and the resisting pole 45 extend from opposite ends of the supporting pole 43. An extension direction of the installation pole 41 is opposite to an extension direction of the resisting pole 45. A plastic sleeve 451 is attached to the resisting pole 45, to increase a friction between the supporting member 40 and a plane, such as a desk.

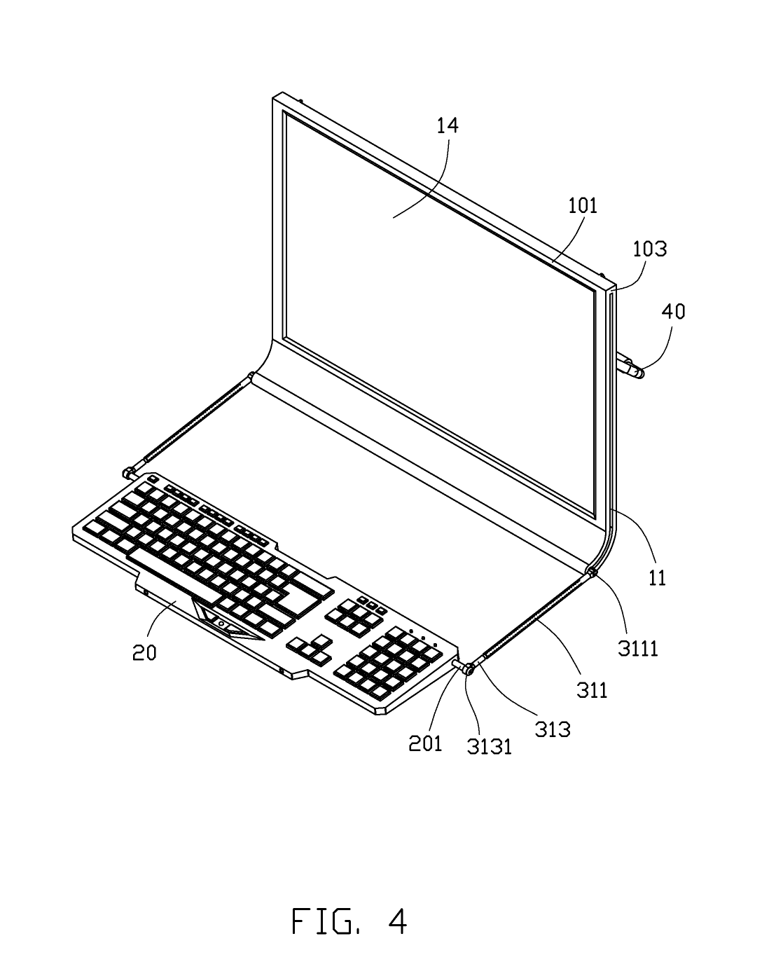

FIGS. 4-6 show that in assembly, the sliding portion 331 of the sliding portion extends through the narrow portion 113 to be engaged into the wide portion 111, and the limiting spacer 335 abuts the corresponding sidewall 103. Each sliding member 33 is thereby slidably engaged in each elongated slot 11.

The stopping tab 3132 of the first pole 311 is pressed into the accommodation hole of the second pole 313 to engage the first pole 311 with the second pole 313. Each rotating shaft 333 is partially engaged in each first installation holes 3113. A first screw 52 is inserted into each rotating shaft 333, to secure a first end of the connecting member 31 to the computer main body 10. Each pivot post 201 is engaged in each second installation hole 3131. A second screw 51 is inserted into a distal end of each pivot post 201, to pivotably secure the second end opposite to the first end of the connecting member 31 to the keyboard 20. The keyboard 20 is thereby assembled with the computer main body 10. The installation pole 41 of the supporting member 40 is inserted into the fixing hole 120 of the fixing portion 12. The resisting pole 45 abuts on the plane, and thus the supporting member 40 is used to support the computer main body 10.

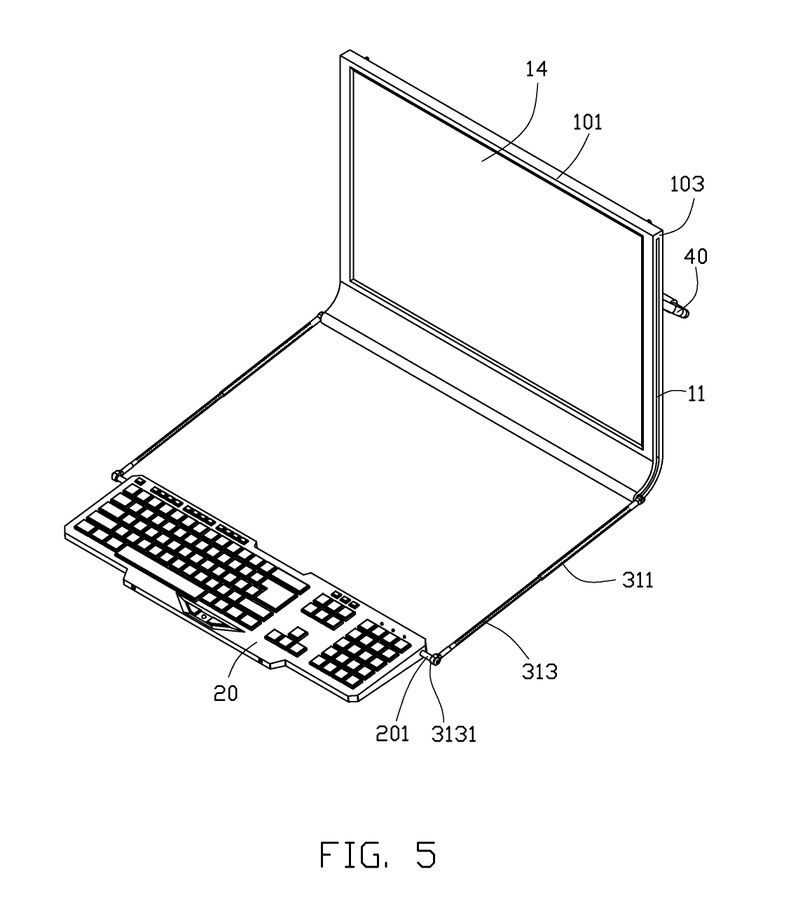

FIGS. 4 and 5 show that the second pole 313 is retractable relative to the first pole 311 between a retracted position and a stretched position. When the second pole 313 is located in the retracted position, the second pole 313 is received in the accommodation hole of the first pole 311. When the second pole 313 is located in the stretched position, the second pole 313 is disengaged from the accommodation hole, and the stopping tab 3132 abuts the blocking flange. The keyboard 20 is located in a used position, where the keyboard 20 is located in the front of the front surface 101 of the computer main body 10.

When the keyboard 20 is not used, the connecting members 31 are moved up to slide the corresponding sliding member 32 up in the elongated slot 11. Simultaneously, the connecting members 31 are rotated along a first direction. The keyboard 20 is rotated along the connecting member 31 to be located in an idle position, where the keyboard 20 abuts the two resisting blocks 15. The two pivot posts 201 hang on the two hooks 17, to prevent the keyboard 20 from rotating relative to the computer main body 10 in succession. Usually, the keyboard 20 is pivoted to locate keys of the keyboard 20 on inner side of the keyboard 20, to prevent the keys from damage.

When the keyboard 20 is needed, the keyboard 20 is lift up, the connecting members 31 is rotated along a second direction opposite to the first direction and each sliding member 32 is slid down along each elongated slot 11, until each sliding member 32 is slid to a bottom portion of corresponding elongated slot 11. The keyboard is rotated along the connecting members 31 to be located in the used position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An all-in-one computer comprising:
a computer main body defining a front surface and a back surface opposite to the front surface;
a keyboard; and
two connecting structures, each of the two connecting structures being connected to the computer main body and the keyboard;
wherein the keyboard is rotatable relative to the computer main body about the two connecting structures between an idle position and a used position, when the keyboard is located on the idle position, the keyboard is located on and abuts the back surface; and when the keyboard is located in the used position, the keyboard is located in front of the front surface.

2. The all-in-one computer of claim 1, wherein the computer main body further comprises two sidewalls, each of the two sidewalls defines an elongated slot, each of the two connecting structures comprises a sliding member, and the sliding member is slidably engaged in the elongated slot.

3. The all-in-one computer of claim 2, wherein the elongated slot is substantially J-shaped.

4. The all-in-one computer of claim 2, wherein each of the two connecting structures further comprises a connecting member, a first end of the connecting member is connected to the sliding member, and a second end of the connecting member is connected to the keyboard.

5. The all-in-one computer of claim 4, wherein the connecting member comprises a first pole and a second pole, the second pole is received in the first pole.

6. The all-in-one computer of claim 5, wherein a first installation portion is located on the first pole, a second installation portion is located on the second pole, the first installation portion surrounds on the sliding member, and the second installation portion surrounds on the keyboard.

7. The all-in-one computer of claim 1, wherein two hooks are located on the back surface, when the keyboard is located on the idle position, the keyboard hangs on the two hooks; when the keyboard is located on the used position, the keyboard is disengaged from the two hooks.

8. The all-in-one computer of claim 1, wherein a protrusion block is located on the back surface, two wedge-shaped resisting blocks are located on the back surface and connected to the protrusion block; when the keyboard is located on the idle position, the keyboard abuts on the two wedge-shaped resisting blocks; when the keyboard is located on the used position, the keyboard is disengaged from the two wedge-shaped resisting blocks.

9. The all-in-one computer of claim 8, further comprising a supporting member, wherein a fixing portion is located on the protrusion block, the supporting member is engaged with the fixing portion and supports the computer main body.

10. The all-in-one computer of claim 9, wherein the supporting member comprises an installation pole, a resisting pole, a supporting pole connected to the installation pole and the resisting pole; the fixing portion defines a fixing hole, the installation pole is engaged in the fixing hole, and the resisting pole supports the computer main body.

11. An all-in-one computer comprising:
a computer main body comprising a front surface and a back surface opposite to the front surface;
a keyboard; and
two connecting structures, a first end of each of the two connecting structures being pivotably engaged in the computer main body, and a second end opposite to the first end of the two connecting structures being pivotably connected to the keyboard;
wherein each of the two connecting structures is rotatable relative to the computer main body along a first direction to rotate the keyboard to be an idle position, where the keyboard is located on the back of the back surface and abuts the back surface; and along a second direction opposite to the first direction to rotate the keyboard to be a used position, wherein the keyboard is located on the front of the front surface.

12. The all-in-one computer of claim 11, wherein the computer main body further comprises two sidewalls, each of the two sidewalls defines an elongated slot, each of the two connecting structures comprises a sliding member, and the sliding member is slidably engaged in the elongated slot.

13. The all-in-one computer of claim 12, wherein the elongated slot is substantially J-shaped.

14. The all-in-one computer of claim 12, wherein each of the two connecting structures further comprises a connecting member, a first end of the connecting member is connected to the sliding member, and a second end of the connecting member is connected to the keyboard.

15. The all-in-one computer of claim 14, wherein the connecting member comprises a first pole and a second pole, the second pole is received in the first pole.

16. The all-in-one computer of claim 15, wherein a first installation portion is located on the first pole, a second installation portion is located on the second pole, the first installation portion surrounds on the sliding member, and the second installation portion surrounds on the keyboard.

17. The all-in-one computer of claim 11, wherein two hooks are located on the back surface, when the keyboard is located on the idle position, the keyboard hangs on the two hooks; when the keyboard is located on the used position, the keyboard is disengaged from the two hooks.

18. The all-in-one computer of claim 11, wherein a protrusion block is located on the back surface, two wedge-shaped resisting blocks are located on the back surface and connected to the protrusion block; when the keyboard is located on the idle position, the keyboard abuts on the two wedge-shaped resisting blocks; when the keyboard is located on the used position, the keyboard is disengaged from the two wedge-shaped resisting blocks.

19. The all-in-one computer of claim 18, further comprising a supporting member, wherein a fixing portion is located on the protrusion block, the supporting member is engaged with the fixing portion and supports the computer main body.

20. The all-in-one computer of claim 19, wherein the supporting member comprises an installation pole, a resisting pole, a supporting pole connected to the installation pole and the resisting pole; the fixing portion defines a fixing hole, the installation pole is engaged in the fixing hole, and the resisting pole supports the computer main body.
